(19) United States
(12) Patent Application Publication
(10) Pub. No.: US 2012/0054743 A1
(43) Pub. Date: Mar. 1, 2012

(54) Information Processing Apparatus and Client Management Method

(76) Inventor: Yuji Fujiwara, Hamura-shi (JP)

(21) Appl. No.: 13/093,636

(22) Filed: Apr. 25, 2011

(30) Foreign Application Priority Data
Aug. 31, 2010 (JP) 2010-194367

(51) Int. Cl. G06F 9/455

(52) U.S. Cl. 718/1

(57) ABSTRACT

According to one embodiment, an information processing apparatus includes a virtual hard disk image generation module and a delivery module. The virtual hard disk image generation module generates a master virtual hard disk image, first differential virtual hard disk image and second differential virtual hard disk image. The delivery module delivers a pair of the master virtual hard disk image and the first differential virtual hard disk image to a first client computer, and delivers a pair of the master virtual hard disk image and the second differential virtual hard disk image to a second client computer. The virtual hard disk image generation module further generates a third differential virtual hard disk image for update. The delivery module further delivers the third differential virtual hard disk image to the first client computer.

### CROSS-REFERENCE TO RELATED APPLICATIONS

This application is based upon and claims the benefit of priority from Japanese Patent Application No. 2010-194367, filed Aug. 31, 2010; the entire contents of which are incorporated herein by reference.

### FIELD

Embodiments described herein relate generally to an information processing apparatus which manages a program that operates on a client computer, and a client management method which is applied to the information processing apparatus.

### BACKGROUND

A technique has been used for managing an operating system (OS) and an application program, which operate on a client computer, by a server. The client computer downloads a disk image including the OS and application program, for example, from the server, and then executes the downloaded OS and application program. In this technique, the efficiency of management of the client computer and the security of the client computer can be improved since there is no need to execute the update of the OS and application program or the application of security patches in each of client computers.

In addition, use has been made of a virtualization technique by which a plurality of environments, in which different operating systems operate, can be implemented at the same time on a single physical computer. In the virtualization technique, the hardware (physical resources) of a computer is virtualized, and a plurality of virtual machines including different OS's and applications can be executed at the same time.

Furthermore, it is possible to combine the virtualization technique with the above-described technique for managing, by a server, an operating system (OS) and an application program, which operate on a client computer. Thereby, for example, using a disk image including the OS and application program, which has been sent from the server, the OS and the application program can be executed by the virtual machine which operates on the client computer.

However, a single disk image including the OS and application program can be used only in client computers having the same hardware structure (e.g. client computers of the same model). Thus, when a server manages a plurality of models of client computers, it is necessary to create disk images for the respective types. In addition, the computer name, product key, and network information, such as an IP address, need to be set in each of the client computers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual view illustrating an example of a network to which an information processing apparatus according to an embodiment is connected.

FIG. 2 is an exemplary conceptual view illustrating an example of the structure of a client computer which is connected to the information processing apparatus of the embodiment.

FIG. 3 is an exemplary conceptual view illustrating another example of the structure of the client computer which is connected to the information processing apparatus of the embodiment.

FIG. 4 is an exemplary conceptual view illustrating the structure of the information processing apparatus of the embodiment.

FIG. 5 is an exemplary block diagram illustrating the structure of the information processing apparatus of the embodiment.

FIG. 6 is an exemplary view illustrating an example of client information which is used by the information processing apparatus of the embodiment.

FIG. 7 is an exemplary view illustrating an example of driver set information which is used by the information processing apparatus of the embodiment.

FIG. 8 is an exemplary view illustrating an example of master image information which is used by the information processing apparatus of the embodiment.

FIG. 9 is an exemplary view illustrating an example of a hierarchical structure of virtual hard disk files which are used by the information processing apparatus of the embodiment.

FIG. 10 is an exemplary view illustrating examples of virtual hard disk files which are delivered to client computers by the information processing apparatus of the embodiment.

FIG. 11 is an exemplary view illustrating another example of the hierarchical structure of virtual hard disk files which are used by the information processing apparatus of the embodiment.

FIG. 12 is an exemplary view illustrating another examples of virtual hard disk files which are delivered to client computers by the information processing apparatus of the embodiment.

FIG. 13 is an exemplary view illustrating still another example of the hierarchical structure of virtual hard disk files which are used by the information processing apparatus of the embodiment.

FIG. 14 is an exemplary view illustrating still another examples of virtual hard disk files which are delivered to client computers by the information processing apparatus of the embodiment.

FIG. 15 is an exemplary flowchart illustrating an example of the procedure of a master image creation process which is executed by the information processing apparatus of the embodiment.

FIG. 16 is an exemplary view illustrating another example of the master image information which is used by the information processing apparatus of the embodiment.

FIG. 17 is an exemplary flowchart illustrating an example of the procedure of a client management process which is executed by the information processing apparatus of the embodiment.

FIG. 18 is an exemplary view illustrating examples of client computers which are connected to the information processing apparatus of the embodiment.

FIG. 19 is an exemplary view illustrating another example of the client information which is used by the information processing apparatus of the embodiment.

FIG. 20 is an exemplary view illustrating still another example of the client information which is used by the information processing apparatus of the embodiment.

FIG. 21 is an exemplary flowchart illustrating an example of the procedure of a driver set management process which is executed by the information processing apparatus of the embodiment.

FIG. 22 is an exemplary flowchart illustrating an example of the procedure of a delivery image creation process which is executed by the information processing apparatus of the embodiment.

FIG. 23 is an exemplary flowchart illustrating an example of the procedure of an image update process which is executed by the client computer which is connected to the information processing apparatus of the embodiment.

FIG. 24 is an exemplary view illustrating an example of a list which is sent from the information processing apparatus of the embodiment to the client computer.

FIG. 25 is an exemplary flowchart illustrating an example of the procedure of an image update response process which is executed by the information processing apparatus of the embodiment.

### DETAILED DESCRIPTION

Various embodiments will be described hereinafter with reference to the accompanying drawings.

In general, according to one embodiment, an information processing apparatus includes a virtual hard disk image generation module, a storage device, a setup module, and a delivery module. The virtual hard disk image generation module generates a master virtual hard disk image in which an operating system is installed, the operating system being executed on a virtual machine, and generates first and second differential virtual hard disk images which depend on the master virtual hard disk image, the first differential virtual hard disk image corresponding to a first client computer, and the second differential virtual hard disk image corresponding to a second client computer. The storage device stores a client information database comprising computer names of the first and second client computers. The setup module causes a first operating system to execute a first setup process by booting up the first operating system on the virtual machine, causes a second operating system to execute a second setup process by booting up the second operating system on the virtual machine, the first operating system corresponding to a pair of the master virtual hard disk image and the first differential virtual hard disk image and the second operating system corresponding to a pair of the master virtual hard disk image and the second differential virtual hard disk image, reads the computer name of the first client computer from the client information database, sets the read computer name of the first client computer in the first differential virtual hard disk image, reads the computer name of the second client computer from the client information database, and sets the read computer name of the second client computer in the second differential virtual hard disk image. The delivery module delivers the pair of the master virtual hard disk image and the first differential virtual hard disk image to the first client computer in order to execute the first operating system on the virtual machine within the first client computer, and delivers the pair of the master virtual hard disk image and the second differential virtual hard disk image to the second client computer in order to execute the second operating system on the virtual machine within the second client computer. The virtual hard disk image generation module further generates a third differential virtual hard disk image which depends on either the master virtual hard disk image or the first differential virtual hard disk image in order to update the first operating system. The delivery module further delivers the third differential virtual hard disk image to the first client computer.

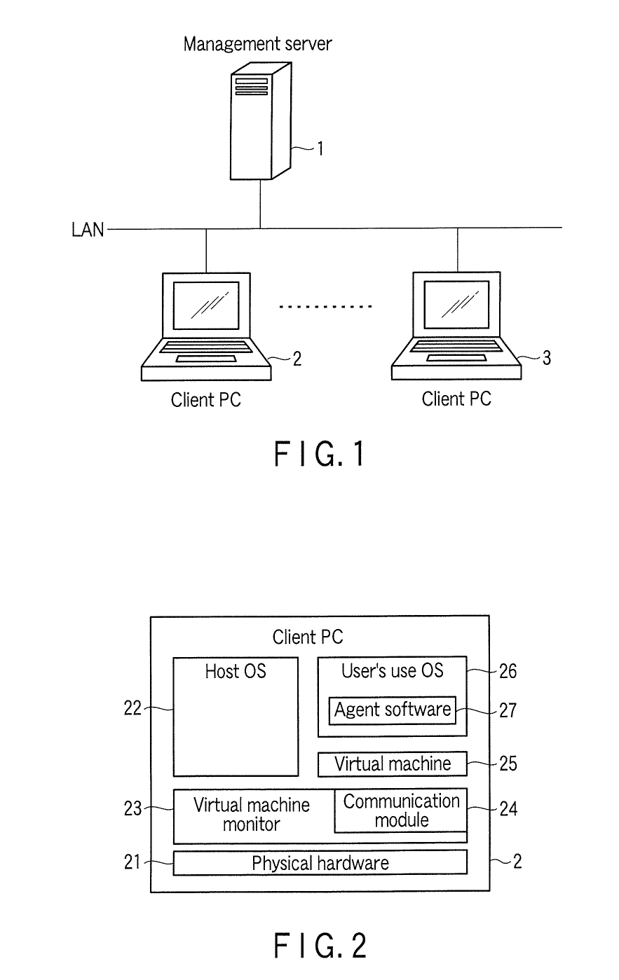

To begin with, referring to FIG. 1, an example of a network, to which an information processing apparatus 1 according to an embodiment is connected, is described. This information processing apparatus 1 may be realized, for example, as a server computer. The information processing apparatus 1 is also referred to as “management server 1”.

The management server 1 and a plurality of client computers 2 and 3 are connected to the network. The management server 1 and client computers 2, 3, are interconnected via the network such as a local area network (LAN). The management server 1 delivers a disk image to each of the client computers 2, 3. This disk image is a disk image including an OS and one or more application programs, which are executed on a virtual machine of each of the client computers 2, 3. By delivering the disk image to the client computers 2, 3, the management server 1 can also update the OS and application programs which are executed on the virtual machines of the client computers 2, 3.

FIG. 2 shows the structure of the client computer 2. Hereinafter, the client computer 2, which is connected to the management server 1, is described by way of example. However, it is assumed that other client computers connected to the management server 1 have the same structure. The client computer 2 includes physical hardware 21, a virtual machine monitor 23, a host OS 22, a virtual machine 25, and a user's use OS 26.

The physical hardware 21 includes hardware resources provided in the client computer 2, such as a processor, a memory, a storage device, and various devices. The virtual machine monitor 23 is also called “hypervisor”, and operates on the physical hardware 21. In addition, the host OS 22 and virtual machine 25 operate on the virtual machine monitor 23. The user's use OS 26 operates on the virtual machine 25.

The virtual machine monitor 23 controls the physical hardware 21 in accordance with an instruction output by the host OS 22, and an instruction output by the user's use OS 26 via the virtual machine 25. The virtual machine monitor 23 allocates the processor to the host OS 22 and the virtual machine 25 on which the user's use OS operates. The virtual machine monitor 23 includes a communication module 24 for communicating with the management server 1. The communication module 24 receives a disk image delivered from the management server 1. The disk image includes an OS image of the user's use OS 26.

The host OS 22 is also called “management OS”, and has a management function of managing a user interface and the virtual machine. The host OS 22 operates on the virtual machine monitor 23. Specifically, an instruction, which is output by the host OS 22, is output to the physical hardware 21 via the virtual machine monitor 23.

The user's use OS 26 is also called “guest OS”, and refers to an OS which is used by the user who uses the client computer 2. The user's use OS 26 operates on the virtual machine 25, as described above. The virtual machine 25 executes the user's use OS 26 by using the disk image including the OS image of the user's use OS 26, which has been delivered from the management server 1. The disk image is, for example, data of a virtual hard disk (VHD) file format.

The disk image includes data of driver programs corresponding to the client computer 2. In addition, the user's use OS 26 includes agent software 27. The agent software 27 installs the driver programs into the user's use OS 26. Hence, the user can use the user's use OS 26 which operates on the virtual machine 25.

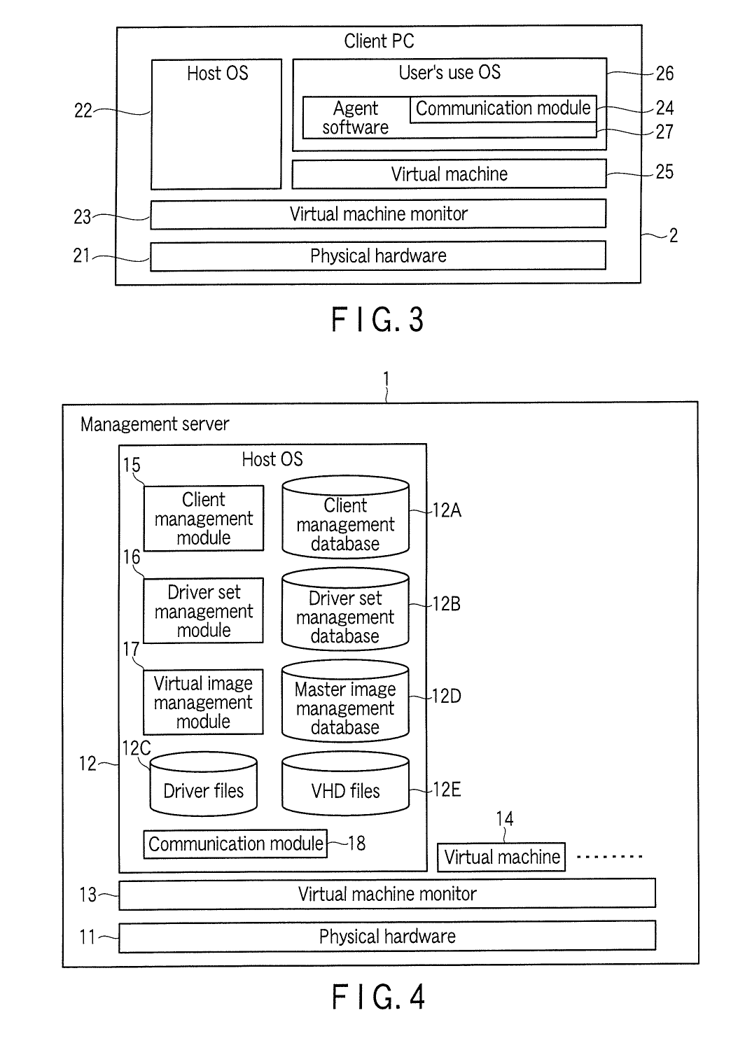

The communication module 24 inquires of the management server 1 as to whether the disk image, which was previously delivered from the management server 1, differs from the disk image which is currently stored in the management server 1, that is, whether the disk image corresponding to the present user's use OS 26 has been updated in the management server 1. If the disk image corresponding to the present user's use OS 26 has been updated in the management server 1, the communication module 24 receives the updated disk image from the management server 1. The communication module 24 receives a disk image from the management server 1. The disk image, for example, includes a difference between the disk image corresponding to the present user's use OS 26 and the associated disk image in the management server 1. As shown in FIG. 3, the communication module 24 may be provided in the agent software 27.

FIG. 4 shows the structure of the management server 1. The management server 1 includes physical hardware 11, a virtual machine monitor 13, a host OS 12, and a virtual machine 14. The management server 1 has a function of delivering a disk image (VHD file) to the client computer 2. The disk image causes the user's use OS 26 to operate on the virtual machine 25 in the client computer 2.

The physical hardware 11 includes hardware resources, such as a processor, a memory, a storage device, and various devices which are provided in the management server 1. The virtual machine monitor 13 is also called “hypervisor”, and operates on the physical hardware 11. In addition, the host OS 12 and virtual machine 14 operate on the virtual machine monitor 13. An arbitrary guest OS can be caused to operate on the virtual machine 14.

The virtual machine monitor 13 controls the physical hardware 11 in accordance with an instruction output by the host OS 12, and an instruction output by the guest OS via the virtual machine 14. The virtual machine monitor 13 allocates the processor to the host OS 12 and the virtual machine 14 on which the guest OS operates.

The host OS 12 is also called “management OS”, and has a management function of managing a user interface and the virtual machine. The host OS 12 operates on the virtual machine monitor 13. Specifically, an instruction, which is output by the host OS 12, is output to the physical hardware 11 via the virtual machine monitor 13.

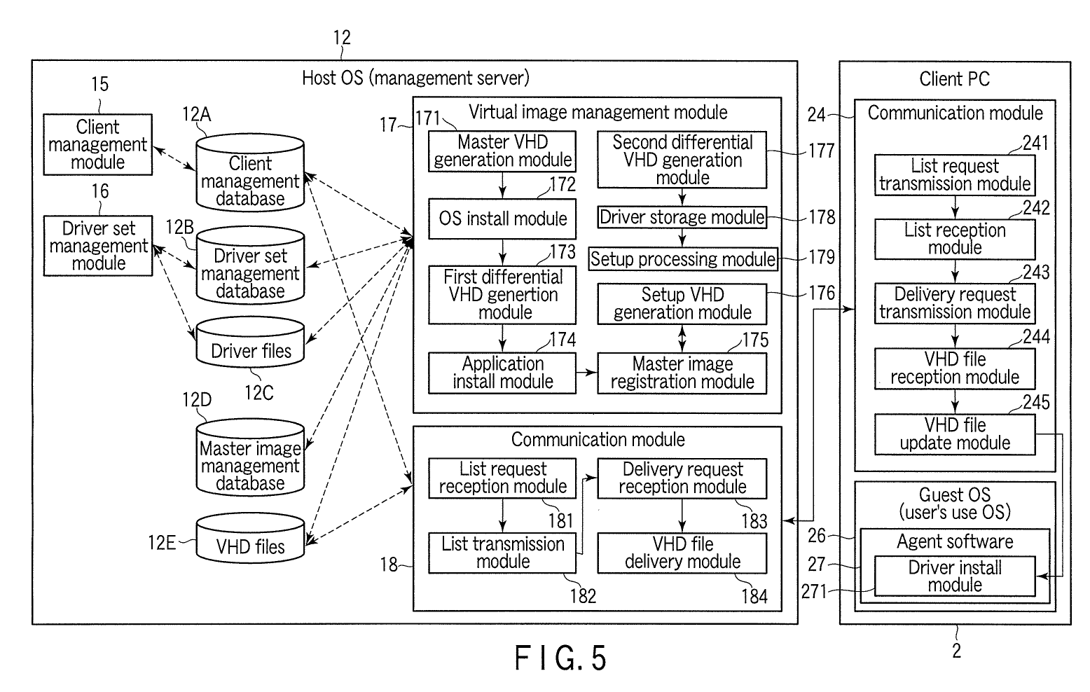

Referring to FIG. 5, a description is given of the structure of the host OS 12 which operates on the management server 1. The host OS 12 includes a client management module 15, a driver set management module 16, a virtual image management module 17, a communication module 18, a client management database 12A, a driver set management database 12B, driver files 12C, a master image management database 12D, and virtual disk files (VHD files) 12E.

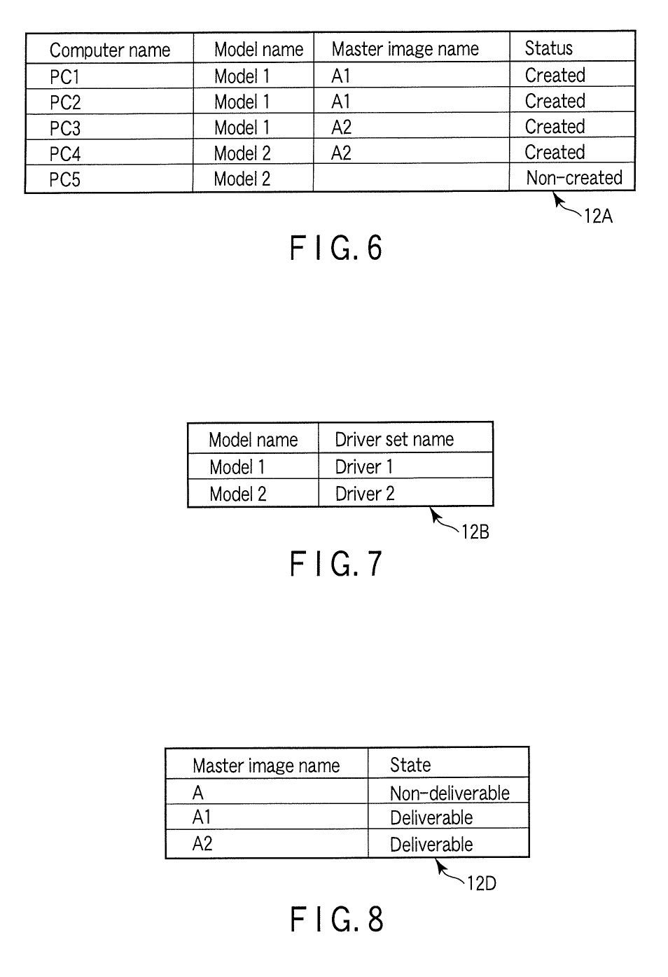

The client management module 15 manages the client management database 12A. FIG. 6 illustrates a structure example of client information which is stored in the client management database 12A. The client information includes a plurality of entries corresponding to a plurality of client computers. Each entry includes, for example, a client name, a model name, a master image name, and a status. The client name is indicative of the computer name of an associated client computer. The model name is indicative of the model name of the associated client computer. Client computers, for which different model names are set, have, for example, different computer hardware structures. The master image name is indicative of the name of a master virtual hard disk file. In the master virtual hard disk, a user's use OS used in the associated client computer is installed. The status is indicative of whether the disk image, which is to be delivered to the client computer, has already been created. In the status, for example, either “Created” or “Non-created” is set. The “Created” indicates that the disk image, which is to be delivered to the client computer, has already been created. The “Non-created” indicates that the disk image, which is to be delivered to the client computer, has not yet been created. The client management module 15 executes addition, edit, delete, etc. of the entry corresponding to the client computer.

The driver set management module 16 manages the driver set management database 12B. FIG. 7 illustrates a structure example of driver set information which is stored in the driver set management database 12B. The driver set information includes a plurality of entries corresponding to the models of a plurality of client computers. The driver set information includes, for example, model names and driver set names. The model name is indicative of the model name of the associated client computer. The model name corresponds to the model name included in the above-described client information. The driver set name is indicative of the name of a driver set which is used in the client computer. The driver set includes driver programs for using, e.g. devices which are connected to the associated client computer. Specifically, by installing the driver set program corresponding to the model of the client computer, it becomes possible to control, e.g. the device connected to the client computer. This driver set is stored, for example, in the storage device in the management server 1 as the driver files 12C. The driver set management module 16 executes addition, edit, delete, etc. of the entry corresponding to the model of the client computer.

The virtual image management module 17 manages the generation and update of a virtual image (virtual hard disk file) which is used in the client computer 2.

Virtual hard disk files include two types of virtual disk files. One is a master virtual hard disk file (basic virtual hard disk file), and the other is a differential virtual hard disk file. The differential virtual hard disk file records an alteration to the basic virtual hard disk file. The differential virtual hard disk file is paired with the basic virtual hard disk file when the differential virtual hard disk file is used. The basic virtual hard disk file and differential virtual hard disk file have a hierarchical structure that the basic virtual hard disk file is “parent” and the differential virtual hard disk file is “child”. In other words, the differential virtual hard disk file that is “child” depends on the basic virtual hard disk file that is “parent”. In the meantime, as the parent of the differential virtual hard disk file, not only the basic virtual hard disk file but also a differential virtual hard disk file may be designated. It is thus possible to constitute a hierarchical structure including a basic virtual hard disk file as a top level, in such a manner that a first differential virtual hard disk file, whose parent is the top-level basic virtual hard disk, is designated as the parent of a second differential virtual hard disk file. Moreover, a plurality of differential virtual hard disk files may be set as children of a single parent (basic virtual hard disk file or differential virtual hard disk file).

By using the pair of the basic virtual hard disk file (parent) and differential virtual hard disk file (child) having the hierarchical structure, different system environments can easily be created. For example, a system environment in which an OS is installed is created in a master virtual hard disk file, and a system environment in which a security patch is applied is created in a differential virtual hard disk file. In addition, for example, a system environment in which the OS is installed is created in a master virtual hard disk file, and a system environment in which an application program is installed is created in a differential virtual hard disk file. Besides, for example, a system environment in which the OS and an application program are installed is created in a master virtual hard disk file, and a plurality of system environments with different computer names are created by setting different computer names in a plurality of differential virtual hard disk files. As described above, since only an alternation to the parent system environment is recorded in the differential virtual hard disk file, the disk capacity that is required for recording may be a minimum necessary capacity.

The virtual hard disk file includes identification information (UUID: universally unique identifier) which is unique to this virtual hard disk file. The UUID is set in, for example, a UUID field included in the footer of the virtual hard disk file.

The differential virtual hard disk file includes a UUID (Parent unique ID) indicative of a virtual hard disk file which is designated to be the “parent” of this differential virtual hard disk file. The UUID of the parent virtual hard disk file is set in, for example, a “Parent unique ID” field which is included in the header of the child differential virtual hard disk file. Specifically, the ID of the parent virtual hard disk file (basic virtual hard disk file or differential virtual hard disk file) is detected from the child differential virtual hard disk.

The virtual image management module 17 includes a master VHD generation module 171, an OS install module 172, a first differential VHD generation module 173, an application install module 174, a master image registration module 175, a setup VHD generation module 176, a second differential VHD generation module 177, a driver storage module 178, and a setup processing module 179.

The master VHD generation module 171 generates a basic virtual hard disk file (basic VHD file) which is used as a master image. The master image is, for example, an OS image in which an OS is installed. The master image is also referred to as “master virtual hard disk image”. When different OSs (user's use OSs 26) are used in the client computers 2, 3, which are connected to the management server 1, the master VHD generation module 171 generates that number of basic VHD files, which is equal to the number of OSs. The master VHD generation module 171 gives a name (master image name) to the generated basic VHD file. This name may be given by an administrator who uses the management server 1. The master VHD generation module 171 outputs the generated basic VHD file to the OS install module 172.

The OS install module 172 installs a predetermined operating system (OS) in the basic VHD file which has been generated by the master VHD generation module 171. Specifically, the OS install module 172 mounts the basic VHD file on the virtual machine 14, and installs the OS in the mounted basic VHD file. Then, the OS install module 172 installs the agent software 27 in the basic VHD file. The OS install module 172 outputs the basic VHD file (master image), in which the OS and the agent software 27 are installed, to the first differential VHD generation module 173.

The first differential VHD generation module 173 generates a first differential VHD file by using the basic VHD file which has been output by the OS install module 172. In other words, the first differential VHD generation module 173 generates a first differential VHD file whose parent is the basic VHD file (i.e. a first differential VHD file depending on the basic VHD file). This first differential VHD file is also used as a master image. When different application program sets are used in client computers which are of the plural client computers 2, 3 connected to the management server 1, and which use the same OS (user's use OS 26), the first differential VHD generation module 173 creates that number of first differential VHD files, which is equal to the number of the application program sets, with respect to one basic VHD file. The first differential VHD generation module 173 gives a name (master image name) to the first differential VHD file. This name may be given by the administrator who uses the management server 1. The first differential VHD generation module 173 outputs the generated first differential VHD file to the application install module 174.

The application install module 174 installs a predetermined application program in the first differential VHD file output by the first differential VHD generation module 173. Specifically, the application install module 174 mounts the first differential VHD file on the virtual machine 14, and then installs the application program in the mounted first differential VHD file. The application install module 174 may install an update program, such as a security patch of the OS, in the first differential VHD file. The application install module 174 outputs the first differential VHD file to the master image registration module 175.

The master image registration module 175 registers the master image information indicative of the basic VHD file and first differential VHD file, which have been created as described above, in the master image management database 12D. The master image registration module 175 registers an entry, which correspond to the created VHD file, in the master image management database 12D. The entry includes “master image name” and “state” of the created VHD file. In the “state” included in this entry, “Non-deliverable” is set.

FIG. 8 illustrates a structure example of master image information which is stored in the master image management database 12D. The master image information includes a plurality of entries corresponding to a plurality of master images. The master image information includes, for example, a master image name and a state. The master image name is indicative of the name of the associated master image. The state indicates whether the master image is deliverable to the client computer. As the state, for example, either “Deliverable” or “Non-deliverable” is set. The “Deliverable” indicates that the master image can be delivered. The “Non-deliverable” indicates that the master image cannot be delivered. The master image registration module 175 executes addition, edit, delete, etc. of the entry corresponding to the master image.

The setup VHD generation module 176 generates a setup differential VHD file in which a setup module is embedded. The setup module is a module for executing a setup process for the OS, when the OS is booted up. The setup process includes, for example, a process of setting a computer name, a process of setting a product key, a process of setting network information such as an IP address, and a process of setting user information such as a user name.

Specifically, the setup VHD generation module 176 firstly generates a differential VHD file whose parent is the first differential VHD file. That is, a differential VHD file depends on the first differential VHD file. Then, the setup VHD generation module embeds the setup module in the generated differential VHD file. This differential VHD file, in which the setup module is embedded, is also referred to as “setup differential VHD file”. In the meantime, in the process by the setup VHD generation module 176, for example, the sysprep tool of the Windows (trademark) OS may be used. The setup VHD generation module 176 notifies the master image registration module 175 that the setup differential VHD file has been generated.

In response to the notification by the setup VHD generation module 176, the master image registration module 175 updates the master image management database 12D. The master image registration module 175 sets “Deliverable” in the “state” of the entry corresponding to the first differential VHD file which is the parent of the generated setup difference VHD file.

By the above-described structure, the basic VHD file and first differential VHD file, which are the master images, and the setup differential VHD file, in which the setup module is embedded, are generated. Then, the master image information indicative of the master images is registered in the master image management database 12D.

The above-described client management module 15 selects master images, which are used in the respective client computers, from the master images registered in the master image management database 12D. The master images used in the respective client computers are selected by, for example, the administrator of the management server 1. In addition, the client management module 15 may select the master images used in the respective client computers, by using data indicative of the correspondency between the client computers and master images. The client management module 15 sets the master image name of the selected master image in the entry of the associated client computer.

The second differential VHD generation module 177 generates a second differential VHD file (also referred to as “client VHD file”) in which data necessary for each client computer is stored. Specifically, the second differential VHD generation module 177 determines whether there is a client computer with a status of “Non-created” by referring to the client management database 12A. If there is no client computer with a status of “Non-created”, that is, if the status of all client computers is “Created”, the process is finished. If there is a client computer with a status of “Non-created”, the second differential VHD generation module 177 generates a second differential VHD file for this client computer by copying the setup differential VHD file corresponding to the client computer.

Specifically, the second differential VHD generation module 177 reads a master image name corresponding to the client computer with the status of “Non-created”. The second differential VHD generation module 177 reads a setup differential VHD file whose parent is the VHD file corresponding to the read master image name. The second differential VHD generation module 177 generates the second differential VHD file by copying the read setup differential VHD file. The second differential VHD generation module 177 gives the computer name corresponding to the client computer to the generated second differential VHD file. The second differential VHD generation module 177 outputs the generated second differential VHD file to the driver storage module 178.

The driver storage module 178 mounts the second difference VHD file output by the second differential VHD generation module 177. The driver storage module 178 reads a driver set corresponding to the model of the client computer by referring to the driver set management database 12B. Specifically, the driver storage module 178 reads a driver set name corresponding to the model of the client computer by referring to the driver set management database 12B. Then, the driver storage module 178 reads a driver set corresponding to the read driver set name from the driver files 12C. The driver storage module 178 disposes the read driver set at a predetermined position in the second differential VHD file. In addition, the driver storage module 178 reads a computer name corresponding to the client computer by referring to the client management database 12A. The driver storage module 178 disposes the read computer name at a predetermined position in the second differential VHD file. Then, the driver storage module 178 unmounts the second differential VHD file. The driver storage module 178 outputs the second differential VHD file to the setup processing module 179.

The setup processing module 179 boots up the OS on the virtual machine 14 by using the second differential VHD file which has been output by the second differential VHD generation module 177. Specifically, the setup processing module 179 boots up the OS by using the second differential VHD file, the first differential VHD file that is the parent of the second differential VHD file, and the basic VHD file that is the parent of the first differential VHD file.

When the OS is booted up on the virtual machine 14, the setup process (mini-setup) of the OS is executed by the setup module which is embedded in the second differential VHD file. In this OS setup process, the computer name, which is disposed in the second differential VHD file, is set in the OS. This setup process may include a process of setting a product key, a process of setting network information such as an IP address, and a process of setting information on the user who uses the OS.

The setup processing module 179 rewrites the status of the client information in the client management database 12A to “Created”, the client information corresponding to the client computer when the setup process has been completed. The setup processing module 179 then shuts down the OS that is being executed. Subsequently, the setup processing module 179 halts the virtual machine 14 and then unmounts the VHD file which is used in the execution of the OS.

By the above-described structure, the disk image (also referred to as “delivery image”) which is delivered to the client computer 2 is generated. The delivery image includes, for example, a VHD file which is necessary for executing user's use OS 26 on the virtual machine 25 in the client computer 2. Thus, for example, the delivery image includes the second differential VHD file, the first differential VHD file that is the parent of the second differential VHD file, and the basic VHD file that is the parent of the first differential VHD file. The above description has been given of the process of generating the disk images which are delivered to one client computer 2. However, disk images, which are delivered to each of the client computers connected to the management server 1, are generated by the same process. Without creating the first differential VHD file in which the application program is installed, the second differential VHD file whose parent is the basic VHD file may be generated. In this case, the second differential VHD file and the basic VHD file are delivered to the client computer 2.

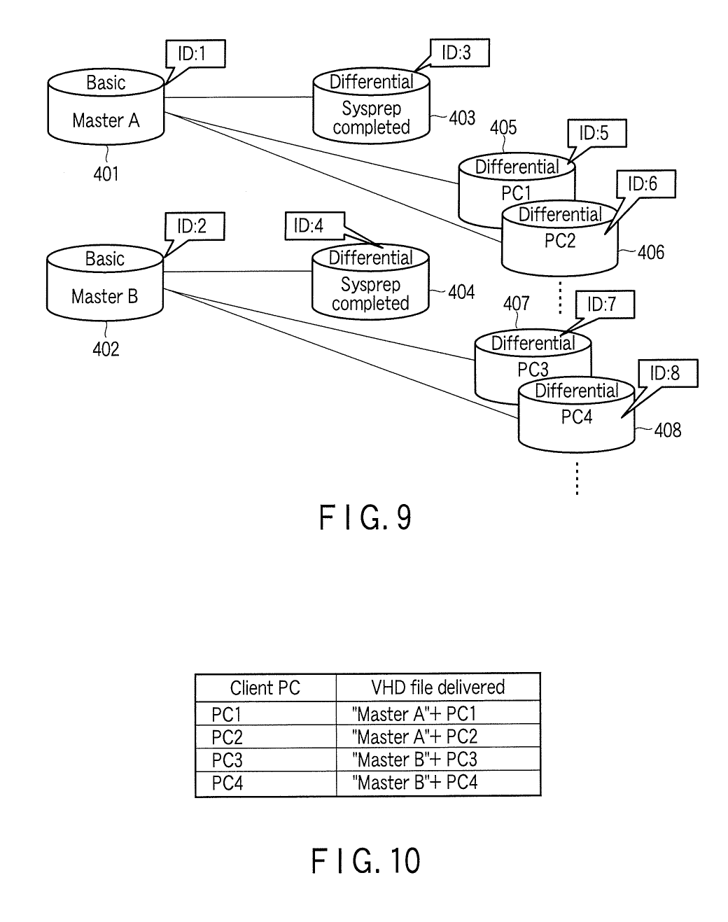

FIG. 9 illustrates an example of the hierarchical structure of VHD files which are used as delivery images. An ID (UUID) is set for each VHD file. For example, an ID “1” is set for a basic VHD file 401. In addition, for example, an ID “5” is set for a basic VHD file 405. Two VHD files, which are connected by solid lines in FIG. 9, indicate that a VHD file which is depicted on the left side is a parent VHD file and a VHD file which is depicted on the right side is a child VHD file. For example, the parent of the differential VHD file 405 and the differential VHD file 406 is the basic VHD file 401.

In the example shown in FIG. 9, the basic VHD file 401 (master A) and basic VHD file 402 (master B) are generated as master images. The differential VHD file 405 (PC1), differential VHD file 406 (PC2), differential VHD file 407 (PC3), and differential VHD file 408 (PC4) are generated as client VHD files.

A differential VHD file 403 and a differential VHD file 404 are setup differential VHD files which are generated by the setup VHD generation module 176. Accordingly, each of the differential VHD files 405 and 406 is a differential VHD file which is generated by copying the differential VHD file 403. In addition, each of the differential VHD files 407 and 408 is a differential VHD file which is generated by copying the differential VHD file 404.

FIG. 10 shows VHD files which are delivered to client computers when the VHD files are structured as shown in FIG. 9. In the structure of the VHD files shown in FIG. 9, the basic VHD file 401 (master A) and differential VHD file 405 (PC1) are delivered to the PC1. The basic VHD file 401 (master A) and differential VHD file 406 (PC2) are delivered to the PC2. The basic VHD file 402 (master B) and differential VHD file 407 (PC3) are delivered to the PC3. The basic VHD file 402 (master B) and differential VHD file 408 (PC4) are delivered to the PC4.

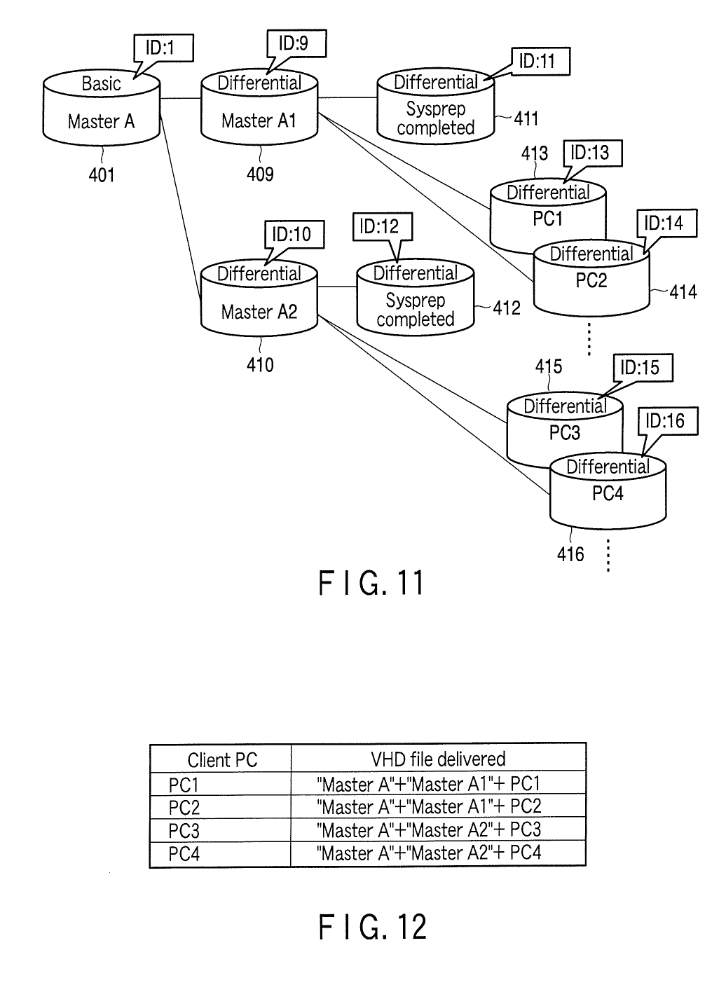

FIG. 11 illustrates another example of the hierarchical structure of VHD files which are used as delivery images.

In the example shown in FIG. 11, a basic VHD file 401 (master A), a differential VHD file 409 (master A1) and a differential VHD file 410 (master A2) are generated as master images. A differential VHD file 413 (PC1), a differential VHD file 414 (PC2), a differential VHD file 415 (PC3), and a differential VHD file 416 (PC4) are generated as client VHD files.

Each of a differential VHD file 411 and a differential VHD file 412 is a setup differential VHD file which is generated by the setup VHD generation module 176. Accordingly, each of the differential VHD files 413 and 414 is a differential VHD file which is generated by copying the differential VHD file 411. In addition, each of the differential VHD files 415 and 416 is a differential VHD file which is generated by copying the differential VHD file 412.

FIG. 11 shows VHD files which are delivered to client computers when the VHD files are structured as shown in FIG. 11. In the structure of the VHD files shown in FIG. 11, the basic VHD file 401 (master A), differential VHD file 409 (master A1) and differential VHD file 413 (PC1) are delivered to the PC1. The basic VHD file 401 (master A), differential VHD file 409 (master A1) and differential VHD file 414 (PC2) are delivered to the PC2. The basic VHD file 401 (master A), differential VHD file 410 (master A2) and differential VHD file 415 (PC3) are delivered to the PC3. The basic VHD file 401 (master A), differential VHD file 410 (master A2) and differential VHD file 416 (PC4) are delivered to the PC4. Such delivery images are delivered to the client computer 2 by the communication module 18.

The communication module 18 manages the delivery of the disk images to the client computer 2. The communication module 18 delivers the disk images to the client computer 2 by communicating with the communication module 24 provided in the client computer 2.

The communication module 18 of the management server 1 (host OS 12) includes a list request reception module 181, a list transmission module 182, a delivery request reception module 183, and a VHD file delivery module 184. The communication module 24 of the client computer 2 includes a list request transmission module 241, a list reception module 242, a delivery request transmission module 243, a VHD file reception module 244, and a VHD file update module 245.

The list request transmission module 241 of the client computer 2 transmits a request for transmission a VHD file list to the management server 1. The VHD file list (also referred to as “ID list”) is a list including IDs corresponding to a plurality of VHD files (disk images) which are used in the client computer 2.

The list request reception module 181 of the management server 1 receives the request for transmission of the VHD file list, which has been transmitted by the client computer 2. The list request reception module 181 notifies the list transmission module 182 that the transmission of the VHD file list has been requested.

In response to the notification, the list transmission module 182 generates a list of VHD files, which are to be delivered to the client computer 2. Specifically, the list transmission module 182 reads the status of the client information corresponding to the client computer by referring to the client management database 12A. The list transmission module 182 determines whether the read status is “Created” or not. If the read status is “Created”, the list transmission module 182 reads the VHD file for the client computer 2 from the VHD files 12E. For example, the list transmission module 182 reads the VHD file to which the computer name corresponding to the client computer 2 is given. The list transmission module 182 detects the ID of the VHD file from the read VHD file. The list transmission module 182 adds the ID of the detected VHD file to the VHD file list.

Then, the list transmission module 182 determines whether there is a parent VHD file of the read VHD file. For example, when the read VHD file is a differential VHD file, the list transmission module 182 determines that there is a parent VHD file of this VHD file. In addition, for example, when the ID of the parent is set in the read VHD file, the list transmission module 182 determines that there is the parent VHD file of this VHD file.

When there is the parent VHD file of the read VHD file, the list transmission module 182 reads the parent VHD file from the VHD files 12E. The list transmission module 182 detects, from the read parent VHD file, the ID of this VHD file. The list transmission module 182 adds the detected ID of the VHD file to the VHD file list. In this manner, the list transmission module 182 adds the ID to the VHD file list by tracing back to the parent VHD file. Specifically, the list transmission module 182 repeats the process adding the ID to the VHD file list, until reaching the parent that is the basic VHD file.

When there is no parent VHD file of the read VHD file, that is, when the read VHD file is the basic VHD file, the list transmission module 182 rearranges the IDs which have been added to the VHD file list. Specifically, the list transmission module 182 rearranges the IDs in the order from the parent to the child, beginning with the ID corresponding to the basic VHD file.

After the IDs in the VHD file list have been rearranged, or when the read status is not “Created”, the list transmission module 182 transmits the VHD file list to the client computer 2. When the read status is not “Created”, a VHD file list, which includes no IDs corresponding to the VHD file, is transmitted.

The list reception module 242 of the client computer 2 receives the VHD file list which has been transmitted by the list transmission module 182 of the management server 1. The list reception module 242 outputs the received VHD file list to the delivery request transmission module 243.

The delivery request transmission module 243 determines whether the currently received VHD file list has been updated from the previously received VHD file list. If the currently received VHD file list has not been updated from the previously received VHD file list, the delivery request transmission module 243 finishes the process. When the currently received VHD file list has been updated from the previously received VHD file list, the delivery request transmission module 243 requests the management server 1 to deliver one or more VHD files which are of the VHD files included in the currently received VHD file list, but which are not included in the previously received VHD file list.

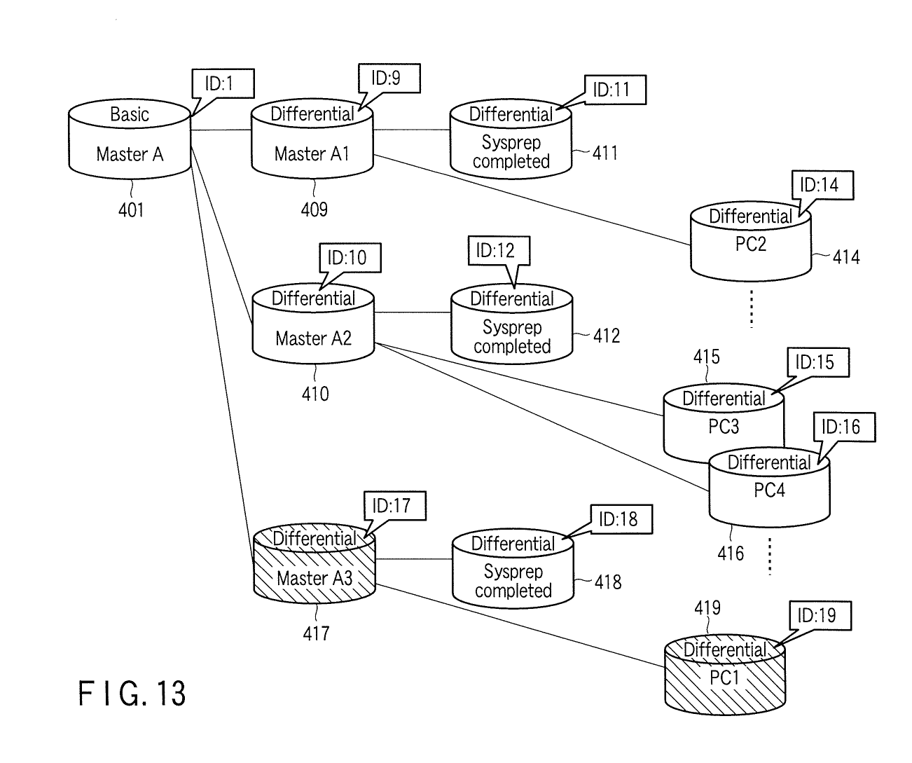

FIG. 13 illustrates an example in which the VHD files, which correspond to the images delivered to the PC1 in the structure shown in FIG. 11, have been altered. Specifically, in FIG. 13, a differential VHD file 417 (master A3) has been added as a master image, and a new differential VHD file 419 for the PC1 has been generated as a child of the master A3. It is assumed that the client computer 2 is the PC1.

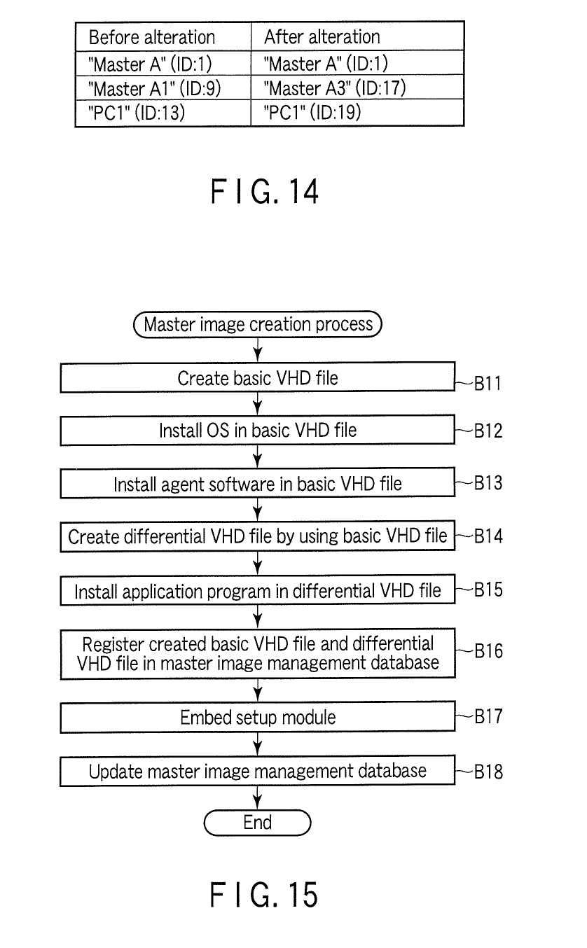

In this case, as shown in FIG. 14, before the VHD files are altered, the list transmission module 182 of the management server 1 transmits a VHD file list including the IDs of the basic VHD file 401 (master A), differential VHD file 409 (master A1) and differential VHD file 413 (PC1) to the client computer 2. Specifically, the list transmission module 182 transmits a VHD file list including the ID “1” of the basic VHD file 401 (master A), the ID “9” of the differential VHD file 409 (master A1) and the ID “13” of the differential VHD file 413 (PC1) to the client computer 2. Besides, after the VHD files have been altered, the list transmission module 182 transmits a VHD file list including the IDs of the basic VHD file 401 (master A), differential VHD file 417 (master A3) and differential VHD file 419 (PC1) to the client computer 2. Specifically, the list transmission module 182 transmits a VHD file list including the ID “1” of the basic VHD file 401 (master A), the ID “17” of the differential VHD file 417 (master A3) and the ID “19” of the differential VHD file 419 (PC1) to the client computer 2.

At this time, since the currently received VHD file list is altered from the previously received VHD file list, the delivery request transmission module 243 requests the management server 1 to deliver VHD files which are of the VHD files included in the currently received VHD file list, but which are not included in the previously received VHD file list. That is, the delivery request transmission module 243 requests the management server 1 to deliver the differential VHD file 417 (master A3) and the differential VHD file 419 (PC1). To be more specific, the delivery request transmission module 243 transmits a delivery request including the ID “17” of the differential VHD file 417 and the ID “19” of the differential VHD file 419 (PC1) to the management server 1.

The delivery request reception module 183 of the management server 1 receives the delivery request for the VHD files by the client computer 2. Then, the delivery request reception module 183 notifies the VHD file delivery module 184 that the delivery request for the VHD files has been received from the client computer 2.

Based on the IDs of the VHD files designated by the delivery request, the VHD file delivery module 184 reads the corresponding VHD files from the VHD files 12E. The VHD file delivery module 184 transmits the read VHD files to the client computer 2.

Subsequently, the VHD file reception module 244 receives the VHD files from the management server 1. The VHD file reception module 244 outputs the received VHD files to the VHD file update module 245.

Using the received VHD files, the VHD file update module 245 updates the disk images stored in the client computer 2. The VHD file update module 245 replaces the disk images, for example, when the user's use OS 26 is booted up next time. In the example shown in FIG. 14, the differential VHD file 409 (master A1) and differential VHD file 413 (PC1) are discarded, and the differential VHD file 417 (master A3) and differential VHD file 419 (PC1) are stored as new disk images.

When boot-up is executed with the new disk images, the driver install module 271 installs drivers by using the updated driver set, since the disk images have been updated. The agent software 27 executes a necessary process, as well as the install of drivers, in accordance with the update of the disk image.

By the above-described structure, the time needed for the transmission can be decreased since only altered VHD files of the disk images (VHD files) used in the client computer 2 are transmitted from the management server 1 to the client computer 2.

Next, referring to a flowchart of FIG. 15, a description is given of an example of the procedure of a master image creation process by the virtual image management module 17. In the example illustrated in FIG. 15, a basic VHD file and a first differential VHD file whose parent is this basic VHD file are created. An OS is installed in the basic VHD file. One or more application programs are installed in the first differential VHD file. In the description below, it is assumed that the basic VHD file and the first differential VHD file are used as master images of delivery images which are delivered to the client computer 2, 3.

To start with, the master VHD generation module 171 creates a basic virtual hard disk file (basic VHD file) which is used as a master image (block B11). Then, the OS install module 172 installs a predetermined operating system (OS) in the basic VHD file (block B12). Specifically, the OS install module 172 mounts the basic VHD file on the virtual machine 14, and then installs the OS in the mounted basic VHD file. Then, the OS install module 172 installs the agent software 27 in the basic VHD file (block B13).

Subsequently, the first differential VHD generation module 173 generates a first differential VHD file by using the master image (basic VHD file) (block B14). The application install module 174 installs one or more predetermined application programs in the first differential VHD file (block B15). Specifically, the application install module 174 mounts the first differential VHD file on the virtual machine 14, and then installs the application programs in the mounted first differential VHD file. The master image registration module 175 registers master image information, which is indicative of the thus created basic VHD file and first differential VHD file, in the master image management database 12D (block B16). The master image registration module 175 registers entries, which include the “master image names” and “states” corresponding to the created VHD files, in the master image management database 12D. In the “state” in the entry, “Non-deliverable” is set.

Then, the setup VHD generation module 176 generates a setup differential VHD file in which a setup module is embedded (block B17). The setup module is a module for executing an OS setup process when the OS is booted up. In response to the generation of the setup differential VHD file, the master image registration module 175 updates the master image management database 12D (block B18). Specifically, the master image registration module 175 sets “Deliverable” in the “state” of the entry corresponding to the first differential VHD file (master image) that is the parent of the generated setup differential VHD file.

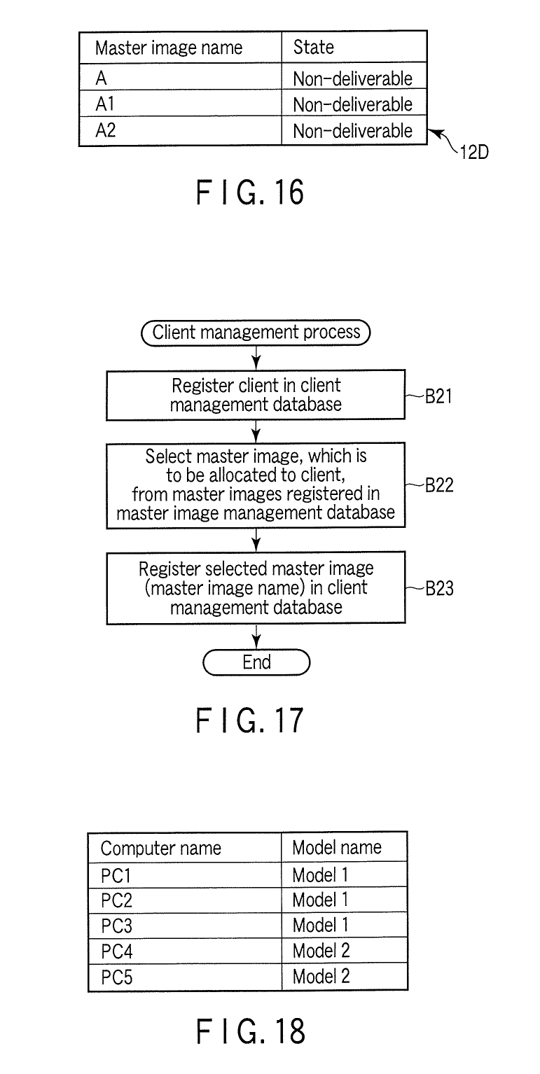

FIG. 16 illustrates an example in which master image information is registered in the master image management database 12D by the master image creation process. The example illustrated in FIG. 16 indicates the master image management database 12D at a time when the VHD files shown in, e.g. FIG. 11 are created. When the VHD files shown in FIG. 11 are created, the basic VHD file 401 that is the master image “A”, the differential VHD file 409 that is the master image “A1” and the differential VHD file 410 that is the master image “A2” are created. Accordingly, in the master image management database 12D, the entries corresponding to the master images “A”, “A1” and “A2” are registered. In addition, “Non-deliverable” is set in the “state” in each entry.

When the setup module has been embedded in each of the differential VHD file 409 that is the master image “A1” and the differential VHD file 410 that is the master image “A2”, “Deliverable” is set in the “state” of each of the entries corresponding to the master images “A1” and “A2” (see FIG. 8).

A flowchart of FIG. 17 illustrates an example of the procedure of a client management process which is executed by the client management module 15. In the description below, it is assumed that five client computers shown in FIG. 18 are managed. Computer names “PC1”, “PC2”, “PC3”, “PC4”, and “PC5” are given to the five client computers. In addition, the model names of the client computers “PC1”, “PC2” and “PC3” are “model 1”. The model names of the client computers “PC4” and “PC5” are “model 2”. In other words, the model for the client computers “PC1”, “PC2” and “PC3” and the model for the client computers “PC4” and “PC5” have different hardware structures.

To start with, the client management module 15 registers the client computers in the client management database 12A (block B21). Specifically, the client management module 15 adds entries of client information indicative of the client computers to the client management database 12A.

Subsequently, the client management module 15 selects master images, which are to be allocated to the client computers, from the master images registered in the master image management database 12D (block B22). The client management module 15 selects, for example, master images which are designated for the respective client computers. In addition, the client management module 15 may allocate master images, which are designated by the administrator, to the client computers.

Then, the client management module 15 registers the master image name, which corresponds to the selected master image, in the client management database 12A (block B23).

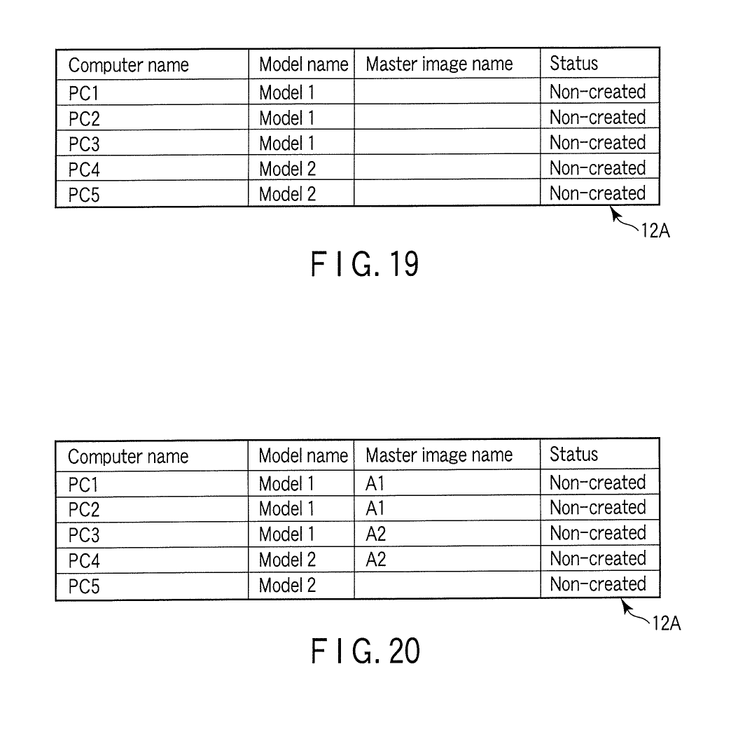

FIG. 19 illustrates an example in which the entries corresponding to the above-described five client computers have been added to the client management database 12A in block B21. For example, as regards the client computer “PC1”, an entry including the computer name “PC1”, the model name “model 1” and the status “Non-created” is added to the client management database 12A. No value is set in the master image name of the added entry. Similarly, the entries corresponding to the client computers “PC2” to “PC5” are added.

FIG. 20 illustrates an example in which master image names have been set in the client management database 12A in block B23. As regards the client computer “PC1”, for example, “A1” is set in the master image name. As regards the client computer “PC3”, for example, “A2” is set in the master image name. As regards the client computer “PC5”, it is indicated that no master image has been selected.

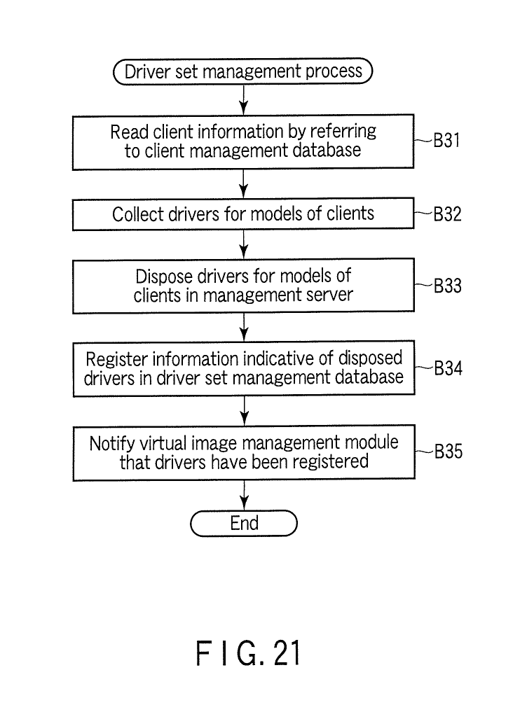

A flowchart of FIG. 21 illustrates an example of the procedure of a driver set management process which is executed by the driver set management module 16.

To start with, the driver set management module 16 reads client information by referring to the client management database (block B31). The driver set management module 16 detects model names included in the client information. For example, in the example of the client management database 12A shown in FIG. 20, “model 1” and “model 2” are detected.

Subsequently, the driver set management module 16 collects a driver set corresponding to each model (block B32). The driver set includes a plurality of necessary drivers (driver programs) for each model. The driver set management module 16 disposes the collected driver set for each model in the management server 1 as driver files 12C (block B33).

Then, the driver set management module 16 registers driver set information, which is indicative of the disposed driver set, in the driver set management database 12B (block B34). Specifically, the driver set management module 16 adds, for example, an entry including the model name and driver set name to the driver set management database 12B. The driver set management module 16 notifies the virtual image management module 17 that the driver set information has been registered in the driver set management database 12B (block B35).

By the above-described process, the driver set information indicating the driver set, which has been collected on a model-by-model basis, is registered in the driver set management database 12B. For example, in the example shown in FIG. 7, it is understood that the driver set of “driver 1” is used for the computer of “model 1”.

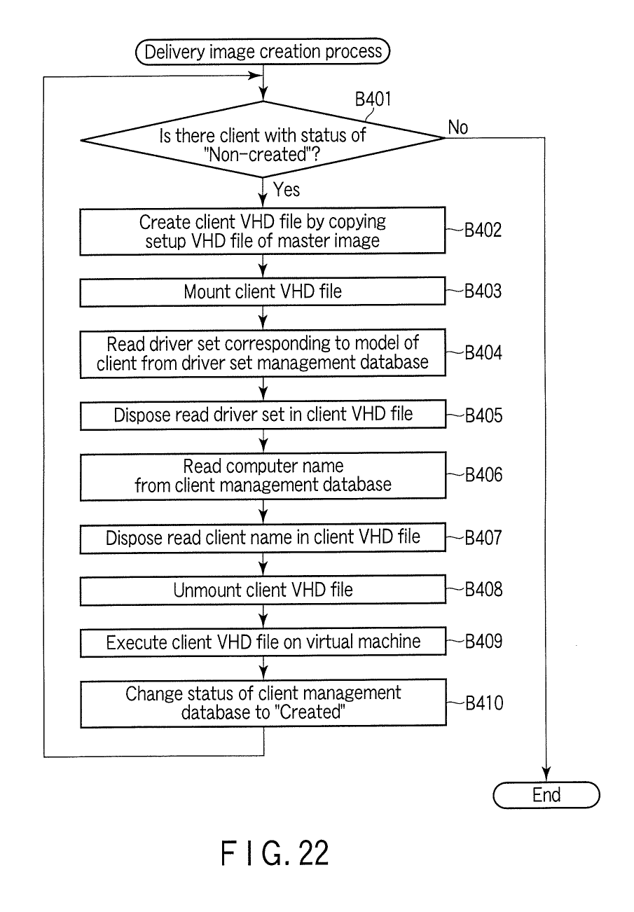

Next, referring to a flowchart of FIG. 22, a description is given of an example of a delivery image creation process which is executed by the virtual image management module 17.

To start with, the second differential VHD generation module 177 determines whether there is a client computer with a status of “Non-created” by referring to the client management database 12A (block B401). If there is no client computer with a status of “Non-created” (NO in block B401), that is, if the status of all client computers is “Created”, the process is finished.

If there is a client computer with a status of “Non-created” (YES in block B401), the second differential VHD generation module 177 generates a second differential VHD file (also referred to as “client VHD file) for the client computer by copying the setup differential VHD file whose parent is the VHD file of the master image corresponding to this client computer (block B402). Then, the driver storage module 178 mounts the created client VHD file (block B403).

Subsequently, the driver storage module 178 reads a driver set corresponding to the model of the client computer by referring to the driver set management database 12B (block B404). Specifically, the driver storage module 178 reads a driver set name corresponding to the model of the client computer referring to the driver set management database 12B. Then, the driver storage module 178 reads a driver set corresponding to the read driver set name from the driver files 12C. The driver storage module 178 disposes the read driver set at a predetermined position in the client VHD file (block B405).

In addition, the driver storage module 178 reads a computer name corresponding to the client computer by referring to the client management database 12A (block B406). The driver storage module 178 disposes the read computer name at a predetermined position in the client VHD file (block B407). Then, the driver storage module 178 unmounts the client VHD file (block B408).

Then, the setup processing module 179 boots up the OS on the virtual machine 14 by using the client VHD file (block B409). Specifically, the setup processing module 179 boots up the OS by using the client VHD file, the first differential VHD file that is the parent of this client VHD file, and the basic VHD file that is the parent of the first differential VHD file.

When the OS is booted up on the virtual machine 14, the setup process (mini-setup) of the OS is executed by the setup module which is embedded in the client VHD file. In this OS setup process, the computer name, which is disposed in the client differential VHD file, is set in the OS. This setup process may include a process of setting a product key, a process of setting network information such as an IP address, and a process of setting information on the user who uses the OS.

When the setup process has been completed, the setup processing module 179 rewrites the status of the client information, which corresponds to the client computer in the client management database 12A, to “Created” (block B410). Then, the setup processing module 179 terminates the OS (virtual machine 14) that is being executed, and returns to block B401.

By the above-described process, the management server 1 can create the delivery image which is delivered to the client computer. At this time, by executing in advance the setup process including the setting of the computer name on the management server 1, it is unnecessary to execute the setup process in the client computer 2. Thereby, it is possible to decrease the time that is needed until the operating system is made usable by using the delivered disk image in the client computer 2.

Moreover, the data amount can be decreased by managing the disk images which are used in a plurality of client computers by using the basic VHD file and differential VHD files. For example, driver sets which are different depending on the models of client computers, and disk images (differential VHD files) including data of, e.g. computer names, which are different between the client computers, are created for the respective clients. The disk image (OS image) in which the OS is installed is created as a basic VHD file which is shared between the client computers. Thereby, it is not necessary to create the OS image for each client computer, and the data amount can be reduced.

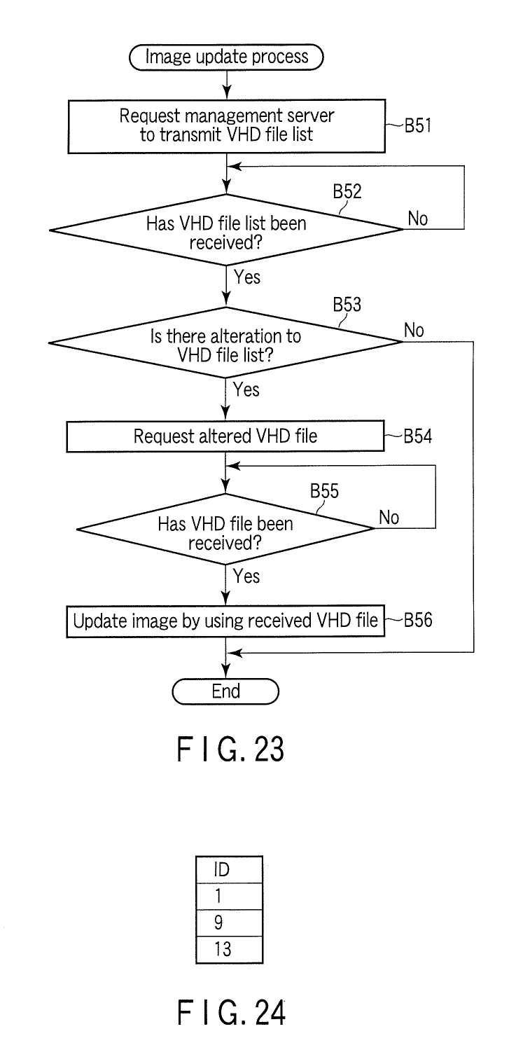

A flowchart of FIG. 23 illustrates an example of the procedure of an image update process which is executed by the communication module 24 provided in the client computer 2.

To start with, the list request transmission module 241 requests the management server 1 to transmit a VHD file list (block B51). The list reception module 242 then determines whether the VHD file list, which is transmitted by the management server 1, has been received (block B52). If the VHD file list has not been received from the management server 1 (NO in block B52), the list reception module 242 stands by, for example, for a predetermined period, and then executes block B52 once again.

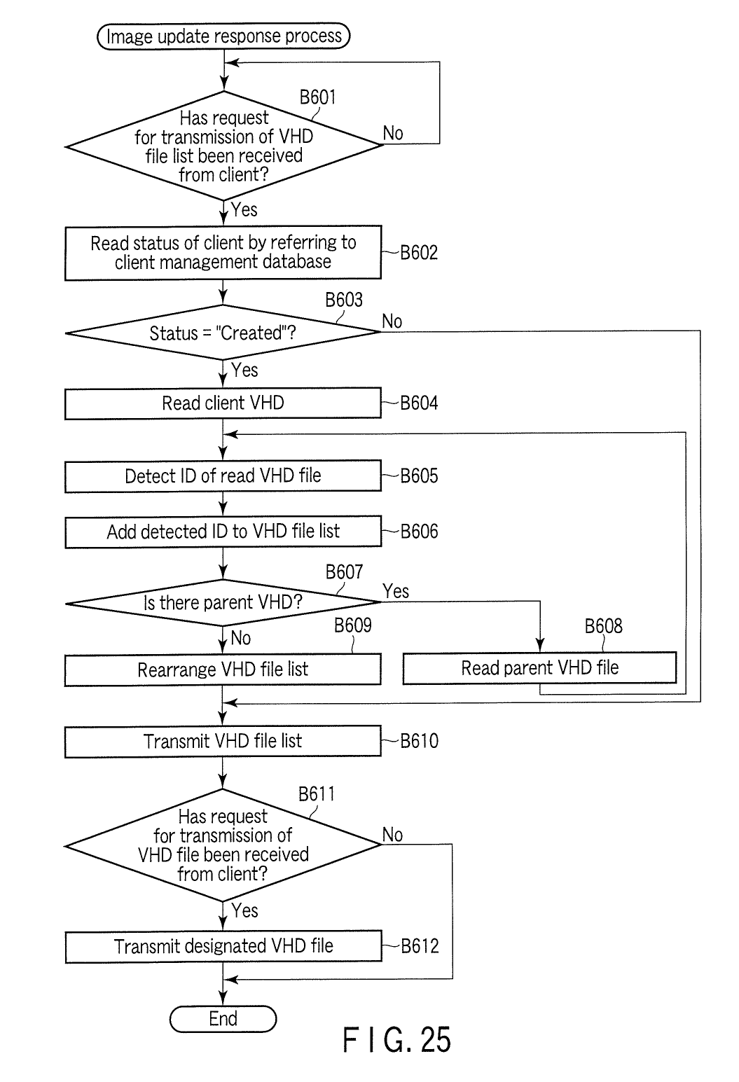

If the VHD file list has been received from the management server 1 (YES in block B52), the list reception module 242 outputs the received VHD file list to the delivery request transmission module 243. The delivery request transmission module 243 determines whether the currently received VHD file list has been altered from the previously received VHD file list (block B53). For example, as shown in FIG. 24, the VHD file list includes IDs corresponding to a plurality of VHD files which are used in the client computer 2. This VHD file list includes, for example, the ID “1” of the basic VHD file 401 (master image A), the ID “9” of the differential VHD file 409 (master image A1) and the ID “13” of the differential VHD file 413 (image for PC1) (see FIG. 11).

If the currently received VHD file list has not been altered from the previously received VHD file list (NO in block B53), the delivery request transmission module 243 finishes the process.

If the currently received VHD file list has been altered from the previously received VHD file list (YES in block B53), the delivery request transmission module 243 requests the management server 1 to deliver one or more VHD files which are of the VHD files included in the currently received VHD file list, but which are not included in the previously received VHD file list (block B54).

Subsequently, the VHD file reception module 244 determines whether the requested VHD files have been received from the management server 1 (block B55). If the requested VHD files have not been received from the management server 1 (NO in block B55), the VHD file reception module 244 stands by, for example, for a predetermined period, and then executes block B55 once again.

If the requested VHD files have been received from the management server 1 (YES in block B55), the VHD file reception module 244 outputs the received VHD files to the VHD file update module 245. Using the received VHD files, the VHD file update module 245 updates the disk image stored in the client computer 2 (block B56). The VHD file update module 245 notifies the driver install module 271 that the disk image has been updated. With the disk image being updated at the time of next boot-up, the driver install module 271 installs drivers by using the updated driver set. The agent software 27 executes a necessary process, as well as the install of drivers, in accordance with the update of the disk image.

A flowchart of FIG. 25 illustrates an example of the procedure of an image update response process which is executed by the communication module 18 provided in the management server 1.

To start with, the list request reception module 181 determines whether a request for transmission of the VHD file list has been received from the client computer (block B601). When the request for transmission of the VHD file list has not been received from the client computer (NO in block B601), the list request reception module 181 stands by, for example, for a predetermined period, and then executes block B601 once again.

When the request for transmission of the VHD file list has been received from the client computer (YES in block B601), the list request reception module 181 notifies the list transmission module 182 that the request for transmission of the VHD file list has been received from the client computer. The list transmission module 182 reads the status of the client information corresponding to the client computer by referring to the client management database 12A (block B602). The list transmission module 182 determines whether the read status is “Created” or not (block B603).

When the read status is “Created” (YES in block B603), the list transmission module 182 reads the VHD file for the client computer from the VHD files 12E (block B604). The list transmission module 182 detects the UUID of the VHD file from the read VHD file (block B605). The list transmission module 182 adds the UUID of the detected VHD file to the VHD file list (block B606).

Then, the list transmission module 182 determines whether there is a parent VHD file of the read VHD file (block B607). For example, when the read VHD file is a differential VHD file, the list transmission module 182 determines that there is a parent VHD file of this VHD file. In addition, for example, when the UUID of the parent is set in the read VHD file, the list transmission module 182 determines that there is the parent VHD file of this VHD file.

If there is the parent VHD file of the read VHD file (YES in block B607), the list transmission module 182 reads the parent VHD file from the VHD files 12E (block B608). Then, the list transmission module 182 returns to the process of block B605.

If there is no parent VHD file of the read VHD file (NO in block B607), that is, if the read VHD file is the basic VHD file, the list transmission module 182 rearranges the IDs which have been added to the VHD file list (block B609). Specifically, the list transmission module 182 rearranges the IDs in the order from the parent to the child, beginning with the ID corresponding to the basic VHD file.

After the IDs in the VHD file list have been rearranged, or if the read status is not “Created” (NO in block B603), the list transmission module 182 transmits the VHD file list to the client computer 2 (block B610). If the read status is not “Created”, for example, a VHD file list, which does not include the ID corresponding to the VHD file, is transmitted.

Subsequently, the delivery request reception module 183 determines whether the delivery request for one or more VHD files has been received from the client computer 2 (block B611). When the delivery request for the VHD files has been received from the client computer 2 (YES in block B611), the delivery request reception module 183 notifies the VHD file delivery module 184 that the delivery request for the VHD files has been received from the client computer 2. Based on the IDs of the VHD files designated by the delivery request, the VHD file delivery module 184 reads the corresponding VHD files from the VHD files 12E. The VHD file delivery module 184 transmits the read VHD files to the client computer 2 (block B612).

By the above-described structure, only altered VHD files of the disk images (VHD files) that are used in the client computer 2 are transmitted from the management server 1 to the client computer 2. Therefore the time needed for the transmission can be decreased.

As has been described above, according to the present embodiment, it is possible to decrease the time that is needed until the operating system is made usable on the virtual machine which operates on the client computer. The management server 1 creates the delivery images which are delivered to the client computer. At this time, by executing in advance the setup process including the setting of the computer name on the management server 1, the time that is needed until the operating system is made usable by using the delivered disk images can be reduced in the client computer 2.

Moreover, the data amount can be decreased by managing the disk images which are used in a plurality of client computers by using the basic VHD file and differential VHD files. For example, driver sets which are different depending on the models of client computers, and disk images (differential VHD files) including data of, e.g. computer names, which are different between the client computers, are created for the respective clients. The disk image (OS image) in which the OS is installed is created as a basic VHD file which is shared between the client computers. Thereby, it is not necessary to create the OS image for each client computer, and the data amount can be reduced.

All the procedures of the virtual image creation process, client management process, driver set management process, delivery image creation process, image update process, and image update response process in this embodiment may be executed by software. Thus, the same advantageous effects as with the present embodiment can easily be obtained simply by installing a computer program, which executes the procedures of the virtual image creation process, client management process, driver set management process, delivery image creation process, image update process, and image update response process, into an ordinary computer through a computer-readable storage medium, and executing this computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a virtual hard disk image generation module configured to generate a master virtual hard disk image in which an operating system is installed, the operating system being executed on a virtual machine, and to generate first and second differential virtual hard disk images which depend on the master virtual hard disk image, the first differential virtual hard disk image corresponding to a first client computer, and the second differential virtual hard disk image corresponding to a second client computer;
a storage device configured to store a client information database comprising computer names of the first and second client computers;
a setup module configured to cause a first operating system to execute a first setup process by booting up the first operating system on the virtual machine, to cause a second operating system to execute a second setup process by booting up the second operating system on the virtual machine, the first operating system corresponding to a pair of the master virtual hard disk image and the first differential virtual hard disk image and the second operating system corresponding to a pair of the master virtual hard disk image and the second differential virtual hard disk image, to read the computer name of the first client computer from the client information database, to set the read computer name of the first client computer in the first differential virtual hard disk image, to read the computer name of the second client computer from the client information database, and to set the read computer name of the second client computer in the second differential virtual hard disk image; and
a delivery module configured to deliver the pair of the master virtual hard disk image and the first differential virtual hard disk image to the first client computer in order to execute the first operating system on the virtual machine within the first client computer, and to deliver the pair of the master virtual hard disk image and the second differential virtual hard disk image to the second client computer in order to execute the second operating system on the virtual machine within the second client computer,
wherein the virtual hard disk image generation module is configured to further generate a third differential virtual hard disk image which depends on either the master virtual hard disk image or the first differential virtual hard disk image in order to update the first operating system, and
the delivery module is configured to further deliver the third differential virtual hard disk image to the first client computer.

2. The information processing apparatus of claim 1, further comprising:
a list transmission module configured to transmit an identifier list to the first client computer in response to an identifier list request by the first client computer, the identifier list comprising one or more identifiers indicative of one or more virtual hard disk images delivered to execute the first operating system; and
an identifier reception module configured to receive an image request from the first client computer, the image request comprising an identifier selected from the identifiers in the identifier list by the first client computer,
wherein the delivery module is configured to deliver either a virtual hard disk image or a differential virtual hard disk image, which corresponds to the identifier in the received image request, to the first client computer.

3. The information processing apparatus of claim 1, wherein the virtual hard disk image generation module is configured to generate the master virtual hard disk image in which the operating system and a predetermined application program are installed, the operating system and the predetermined application program being executed on the virtual machine.

4. The information processing apparatus of claim 1, further comprising:
a list transmission module configured to transmit a first identifier list to the first client computer before the delivery of the pair of the master virtual hard disk image and the first differential virtual hard disk image, the first identifier list comprising an identifier indicative of the master virtual hard disk image and an identifier indicative of the first differential virtual hard disk image, and to transmit a second identifier list to the first client computer when an identifier list request is received from the first client computer after the third differential virtual hard disk image is generated, the second identifier list comprising the identifier indicative of the master virtual hard disk image, the identifier indicative of the first differential virtual hard disk image and an identifier indicative of the third differential virtual hard disk image; and
an identifier reception module configured to receive an image request from the first client computer, the image request comprising the identifier indicative of the third differential virtual hard disk image, which is selected from the identifiers in the second identifier list by the first client computer,
wherein the delivery module is configured to deliver the third differential virtual hard disk image to the first client computer in response to reception of the image request.

5. A client management method comprising:
generating a master virtual hard disk image in which an operating system is installed, the operating system being executed on a virtual machine, and generating first and second differential virtual hard disk images which depend on the master virtual hard disk image, the first differential virtual hard disk image corresponding to a first client computer, and the second differential virtual hard disk image corresponding to a second client computer;
causing a first operating system to execute a setup process by booting up the first operating system on the virtual machine, and causing a second operating system to execute a setup process by booting up the second operating system on the virtual machine, the first operating system corresponding to a pair of the master virtual hard disk image and the first differential virtual hard disk image and the second operating system corresponding to a pair of the master virtual hard disk image and the second differential virtual hard disk image, reading a computer name of the first client computer from a client information database comprising the computer name of the first client computer and a computer name of the second client computer, setting the read computer name of the first client computer in the first differential virtual hard disk image, reading a computer name of the second client computer from the client information database, and setting the read computer name of the second client computer in the second differential virtual hard disk image; and
delivering the pair of the master virtual hard disk image and the first differential virtual hard disk image to the first client computer in order to execute the first operating system on the virtual machine within the first client computer, and delivering the pair of the master virtual hard disk image and the second differential virtual hard disk image to the second client computer in order to execute the second operating system on the virtual machine within the second client computer,
wherein the generating comprises further generating a third differential virtual hard disk image which depends on either the master virtual hard disk image or the first differential virtual hard disk image in order to update the first operating system, and
the delivering comprises further delivering the third differential virtual hard disk image to the first client computer.

6. The client management method of claim 5, further comprising:
transmitting an identifier list to the first client computer in response to an identifier list request by the first client computer, the identifier list comprising one or more identifiers indicative of one or more virtual hard disk images delivered to execute the first operating system; and
receiving an image request from the first client computer, the image request comprising an identifier selected from the identifiers in the identifier list by the first client computer,
wherein the delivering comprises delivering either a virtual hard disk image or a differential virtual hard disk image, which corresponds to the identifier in the received image request, to the first client computer.

7. The client management method of claim 5, wherein the generating comprises generating the master virtual hard disk image in which the operating system and a predetermined application program are installed, the operating system and the predetermined application program being executed on the virtual machine.

8. The client management method of claim 5, further comprising:
transmitting a first identifier list to the first client computer before the delivery of the pair of the master virtual hard disk image and the first differential virtual hard disk image, the first identifier list comprising an identifier indicative of the master virtual hard disk image and an identifier indicative of the first differential virtual hard disk image, and transmitting a second identifier list to the first client computer when an identifier list request is received from the first client computer after the third differential virtual hard disk image is generated, the second identifier list comprising the identifier indicative of the master virtual hard disk image, the identifier indicative of the first differential virtual hard disk image and an identifier indicative of the third differential virtual hard disk image; and
receiving an image request from the first client computer, the image request comprising the identifier indicative of the third differential virtual hard disk image, which is selected from the identifiers in the second identifier list by the first client computer,
wherein the delivering comprises delivering the third differential virtual hard disk image to the first client computer in response to reception of the image request.
